(19) United States
(12) Patent Application Publication
(10) Pub. No.: US 2014/0210260 A1
(43) Pub. Date: Jul. 31, 2014

(54) ELECTRIC POWER CONVERSION SYSTEM FOR ELECTRIC VEHICLE

(71) Applicant: Kentaro HIROSE, Aichi-gun (JP)

(72) Inventor: Kentaro HIROSE, Aichi-gun (JP)

(73) Assignee: TOYOTA JIDOSHA KABUSHIKI KAISHA, Toyota-shi (JP)

(21) Appl. No.: 14/166,942

(22) Filed: Jan. 29, 2014

(30) Foreign Application Priority Data
Jan. 29, 2013 (JP) 2013-013994

(51) Int. Cl. B60L 3/04

(52) U.S. Cl. CPC B60L 3/04
USPC 307/10.1

(57) ABSTRACT

An electric power conversion system for an electric vehicle includes a capacitor operable to smooth a current of the battery, first discharge resistor and second discharge resistor operable to discharge the capacitor, a first substrate attached to a case of the capacitor, and a second substrate in which a circuit that controls the second discharge resistor is mounted. The second discharge resistor rapidly discharges the capacitor while generating a larger amount of heat per unit time per unit current than the first discharge resistor. The case of the capacitor is located between the second discharge resistor and the second substrate. An electrically conducting path that electrically connects the second substrate with the second discharge resistor is routed through the first substrate.

### INCORPORATION BY REFERENCE

The disclosure of Japanese Patent Application No. 2013-013994 filed on Jan. 29, 2013 including the specification, drawings and abstract is incorporated herein by reference in its entirety.

### BACKGROUND OF THE INVENTION

1. Field of the Invention

The invention relates to an electric power conversion system for an electric vehicle. The electric power conversion system is a device that converts DC power of a battery into AC power and supplies the AC power to a motor. The term “electric vehicle” used in this specification includes a hybrid vehicle having both a motor and an engine, and a fuel cell car.

2. Description of Related Art

An electric vehicle is equipped with an electric power conversion system that converts DC power of a battery into AC power having a frequency suitable for motor driving. The electric power conversion system may include not only an inverter circuit for converting DC power into AC power, but also a converter circuit that steps down or boosts the output voltage of the battery.

The electric power conversion system often includes a capacitor or capacitors for smoothing electric current delivered from the battery. The capacitor is connected in parallel with an input end of the inverter circuit, or an input end or output end of the voltage converter circuit. Since the output current of the battery is large, a large-capacity capacitor is employed as the smoothing capacitor. Since the capacitor is connected to a current path from the battery to the motor, a significant amount of electric power is stored in the capacitor when the motor is driven. Therefore, it is preferable to provide a discharge circuit for rapidly discharging the capacitor in an emergency situation, such as a vehicle collision. Examples of electric power conversion system including a capacitor for smoothing DC power of a battery, and a discharge resistor for discharging the capacitor, are illustrated in Japanese Patent Application Publication No. 2012-139014 (JP 2012-139014 A), and Japanese Patent Application Publication No. 2012-152104 (JP 2012-152104 A). In the following description, the “capacitor” means a large-capacity capacitor for smoothing output current of the battery, unless otherwise specified.

Since the amount of heat generated by the discharge resistor for rapidly discharging the capacitor is large, the heat management for the resistor is important. In JP 2012-139014 A and JP 2012-152104 A, it is proposed to locate the capacitor and the discharge resistor on the opposite sides of a coolant channel, so as to cool the discharge resistor.

### SUMMARY OF THE INVENTION

Since the discharge resistor needs to be connected to the capacitor depending on the situation, a control circuit for connecting the discharge resistor to the capacitor or disconnecting the discharge resistor from the capacitor needs to be provided. Where the control circuit is mounted in a substrate (control substrate), it is preferable to locate the control substrate apart from the discharge resistor as a source of heat generation, as far as possible. On the other hand, if the distance between the discharge resistor and the control substrate is increased, the length of a cable that electrically connects the discharge resistor with the control substrate needs to be increased, thus requiring space sufficient for installation of the cable and creative wiring of the cable. The present invention provides a technology of ensuring a sufficient distance between the discharge resistor for discharging the capacitor, and the control substrate that controls the discharge resistor, and also electrically connecting the discharge resistor with the control substrate while assuring space-saving.

The capacitor for smoothing electric current may be connected in parallel with a resistor that has a relatively large resistance value and gradually releases electric charge stored in the capacitor (i.e., discharge the capacitor) over a long period of time. To distinguish this resistor from the above-described resistor for rapidly discharging the capacitor, the resistor that discharges the capacitor over a long period of time will be called “first discharge resistor”, and the resistor for rapid discharge will be called “second discharge resistor”. The first discharge resistor is mounted in a substrate, and is located in the vicinity of the capacitor. In one example of this invention, the substrate in which the first discharge resistor is mounted is used as a relay that electrically connects the second discharge resistor (resistor for rapidly discharging the capacitor) with the control substrate (substrate in which the control circuit for the second discharge resistor is mounted). With this arrangement, the second discharge resistor can be located apart from the control substrate, and the second discharge resistor and the control substrate can be electrically connected to each other in small space.

If the first discharge resistor and the second discharge resistor are compared with each other in another point of view, the first discharge resistor has a larger resistance value than the second discharge resistor. In other words, the amount of electric power consumed by the second discharge resistor (due to heat generation) per unit time is larger than that of the first discharge resistor. Also, the amount of heat generated by the second discharge resistor per unit time per unit current is larger than that of the first discharge resistor.

An electric power conversion system for an electric vehicle, which is operable to convert DC power of a battery into AC power and supply the AC power to a motor, is provided according to one aspect of the invention. The electric power conversion system includes a capacitor operable to smooth an electric current of the battery, a first discharge resistor operable to discharge the capacitor, a first substrate attached to a case of the capacitor, a second discharge resistor operable to discharge the capacitor, an amount of heat generated by the second discharge resistor per unit time per unit current is larger than that generated by the first discharge resistor, and a second substrate in which a circuit that controls the second discharge resistor is mounted. In the power conversion system, the case of the capacitor is located between the second discharge resistor and the second substrate, and an electrically conducting path that electrically connects the second substrate with the second discharge resistor is routed through the first substrate. The first discharge resistor may be a device for gradually discharging the capacitor when an ignition switch of the vehicle is turned OFF, for example. The second discharge resistor may be a device for rapidly discharging the capacitor in the event of a vehicle collision, for example.

The second discharge resistor converts electric energy stored in the capacitor, into thermal energy, and releases the thermal energy. Accordingly, the amount of heat generated by the second discharge resistor per unit time per unit current is larger than that generated by the first discharge resistor. In other words, the first discharge resistor has a larger resistance value than the second discharge resistor, as described above.

The first discharge resistor may be mounted in the first substrate. In one example of the electric power conversion system as described above, a resistor-side cable (or metal terminal) that extends from the second discharge resistor, and a substrate-side cable (or metal terminal) that extends from the second substrate, are both connected to the first substrate, and the resistor-side cable and the substrate-side cable are electrically connected to each other in the first substrate.

With the above arrangement, the second discharge resistor and the second substrate that controls the second discharge resistor are located with the case of the capacitor interposed therebetween, thus assuring a sufficient distance between the second discharge resistor and the second substrate, and these components are electrically connected to each other via the first substrate attached to the case. Namely, the second discharge resistor for rapidly discharging the capacitor and the substrate that controls the second discharge resistor can be electrically connected to each other in small space, while ensuring a sufficient distance between these components.

In the electric power conversion system as described above, the case of the capacitor may be a generally rectangular parallelepiped including a first face, a second face parallel to the first face, and a third face that intersects with the first face and the second face. The second substrate and the second discharge resistor may be located so as to be respectively opposed to the first face and the second face of the case of the capacitor, and the first substrate may be attached to the third face of the case of the capacitor. In other words, in the electric power conversion system as described above, the case of the capacitor may be a generally rectangular parallelepiped including a first face, a second face parallel to the first face, and a third face that intersects with the first face and the second face. The second substrate may be disposed so as to oppose one of the first face or second face, and the second discharge resistor may be disposed so as to oppose the other of the first face or second face. Thus, the first substrate, second substrate, and the second discharge resistor are located so as to be opposed to three side faces of the capacitor case in the form of a generally rectangular parallelepiped, so that the capacitor and a set of devices related to its discharge can be grouped into a compact assembly around the capacitor, and the space efficiency of the capacitor and the devices related to its discharge is improved.

In the electric power conversion system as described above, the first discharge resistor and the second discharge resistor may be connected in parallel with the capacitor, and the control circuit mounted in the second substrate may be operable to connect the second discharge resistor with the capacitor or disconnect the second discharge resistor from the capacitor.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a circuit diagram of an electric power conversion system according to one embodiment of the invention;

FIG. 2 is a perspective view showing a layout of a capacitor and discharge resistors; and

FIG. 3 is a side view showing the layout of the capacitor and the discharge resistors.

### DETAILED DESCRIPTION OF EMBODIMENTS

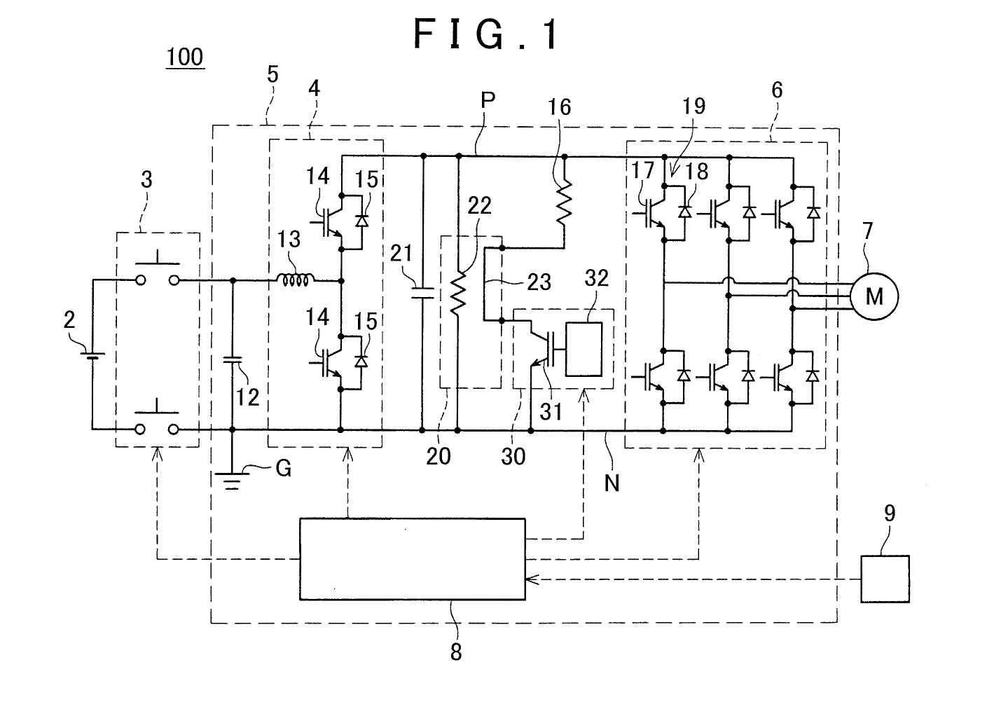

An electric power conversion system according to one embodiment of the invention will be described with reference to the drawings. Initially, an electric system of an electric vehicle 100 including the electric power conversion system of this embodiment will be described. FIG. 1 is a circuit diagram of the electric vehicle 100. The electric vehicle 100 has a main battery 2 as a power supply, and a motor 7 that is driven with electric power supplied from the main battery 2 so as to run the vehicle. In FIG. 1, only those of components necessary for description of this embodiment are illustrated, and other components that are not related to the embodiment are not illustrated.

The main battery 2 is connected to the power conversion system 5 via a system main relay 3. The system main relay 3 is a switch that connects the main battery 2 to the electric system of the vehicle or disconnects the main battery 2 from the electric system. The system main relay 3 is switched by a controller 8. Usually, the controller 8 closes the system main relay 3 when a main switch (which is generally called “ignition switch”) of the vehicle is turned ON, so as to connect the main battery 2 to the electric system of the vehicle. When the main switch of the vehicle is turned OFF, on the other hand, the controller 8 opens the system main relay 3, so as to disconnect the main battery 2 from the electric system of the vehicle. In some cases, the controller 8 opens or closes the system main relay 3, according to a command from another device or controller, aside from a signal from the main switch of the vehicle. A typical example is the case where the controller 8 receives a signal indicative of a vehicle collision. One example of the signal indicative of a vehicle collision is a signal based on a measurement value of an acceleration sensor 9 included in an airbag system. The signal indicates that an acceleration that exceeds a given threshold value is detected.

The output voltage of the main battery 2 is, for example, 300V. The power conversion system 5 includes a voltage converter circuit 4 that boosts the voltage of the main battery 2 to a voltage (e.g., 600V) suitable for driving of the motor, and an inverter circuit 6 that converts DC power with the boosted voltage, into AC power. The output of the inverter circuit 6 corresponds to electric power supplied to the motor 7. Both of the voltage converter circuit 4 and the inverter circuit 6 have switching devices, such as IGBTs, as main components, and the controller 8 produces and supplies drive signals (PWM signals) for driving the switching devices.

The voltage converter circuit 4 boosts the output voltage of the main battery 2, and supplies the resulting power to the inverter circuit 6. The voltage converter circuit 4 consists principally of a reactor 13, two switching devices 14 (such as IGBTs), and two freewheeling diodes 15, as shown in FIG. 1. The inverter circuit 6 has six sets of circuits each consisting of a switching device 17 (such as IGBT) and a freewheeling diode 18 connected inversely in parallel. When the controller 8 supplies a PWM signal as needed to each pair of the switching devices 17, the DC power received by the switching devices 17 is converted into AC power, which is then generated. The motor 7 is driven with the AC power. The configurations of the voltage converter circuit 4 and the inverter circuit 6 are well known, and therefore, will not be described in detail.

The electric power conversion system 5 includes two capacitors 12, 21 for smoothing the output current of the main battery 2. The capacitor 12 is connected in parallel with an input end of the voltage converter circuit 4, and the capacitor 21 is connected in parallel with an output end of the voltage converter circuit 4. The capacitor 12 serves to smooth electric current received by the voltage converter circuit 4 (i.e., input current of the voltage converter circuit 4), and may be called “filter capacitor”. The capacitor 21 serves to smooth output current of the voltage converter circuit 4, and may be called “smoothing capacitor”. The capacitors 12, 21 are large-capacity capacitors provided for the purpose of suppressing (smoothing) pulsation of current supplied from the main battery 2. In FIG. 1, symbol “P” denotes a high-potential-side power line, out of power lines through which electric current for driving the motor 7 flows, and symbol “N” denotes a low-potential-side power line. Since large current flows through these power lines, the power lines are physically formed by members in the form of metal plates called “bus bars”.

A first discharge resistor 22 and a second discharge resistor 16 are connected in parallel with the capacitor 21. The first discharge resistor 22, which has a relatively large resistance value, is provided for gradually discharging electric charge stored in the capacitor 21 after the ignition switch of the vehicle is turned OFF. The first discharge resistor 22 is always connected to the capacitor 21.

The second discharge resistor 16 is connected in parallel with the capacitor 21 via a switching transistor 31. The amount of heat generated by the second discharge resistor 16 per unit time and unit current is larger than that of the first discharge resistor 22. If the second discharge resistor 16 is connected to the capacitor 21, the capacitor 21 can be quickly discharged. Where the capacitor 21 is fully charged, for example, the second discharge resistor 16 can completely discharge the capacitor 21 in seconds.

The second discharge resistor 16 is connected to the capacitor 21 via the switching transistor 31 in the event of a vehicle collision. More specifically, if the controller 8 receives a signal indicative of a collision from the acceleration sensor 9, the controller 8 sends a signal to a control circuit 32, and the control circuit 32 switches the switching transistor 31 from OFF to ON.

When the second discharge resistor 16 is connected to the capacitor 21, the capacitor 12 is also connected to the second discharge resistor 16 through the diode 15; therefore, the capacitor 12 is also discharged at the same time that the capacitor 21 is discharged.

The power conversion system 5 includes a first substrate 20 indicated by a broken line in FIG. 1, and a second substrate 30 indicated by a broken line in FIG. 1. The switching transistor 31 and the control circuit 32 that controls the switching transistor 31 are mounted in the second substrate 30. In other words, the switching transistor 31 and the control circuit 32 correspond to a circuit that controls the second discharge resistor 16. Thus, the circuit that controls the second discharge resistor 16 is mounted in the second substrate 30.

The first discharge resistor 22, and an electrically conducting path 23 (which will be simply called “conducting path”) that electrically connects the second discharge resistor 16 with the second substrate 30, are mounted in the first substrate 20. The conducting path 23 is an elongate, metal plate having smaller electric resistance than a general wire cable. Next, a physical layout of the first substrate 20, second substrate 30, second discharge resistor 16, and the capacitor 21 will be described.

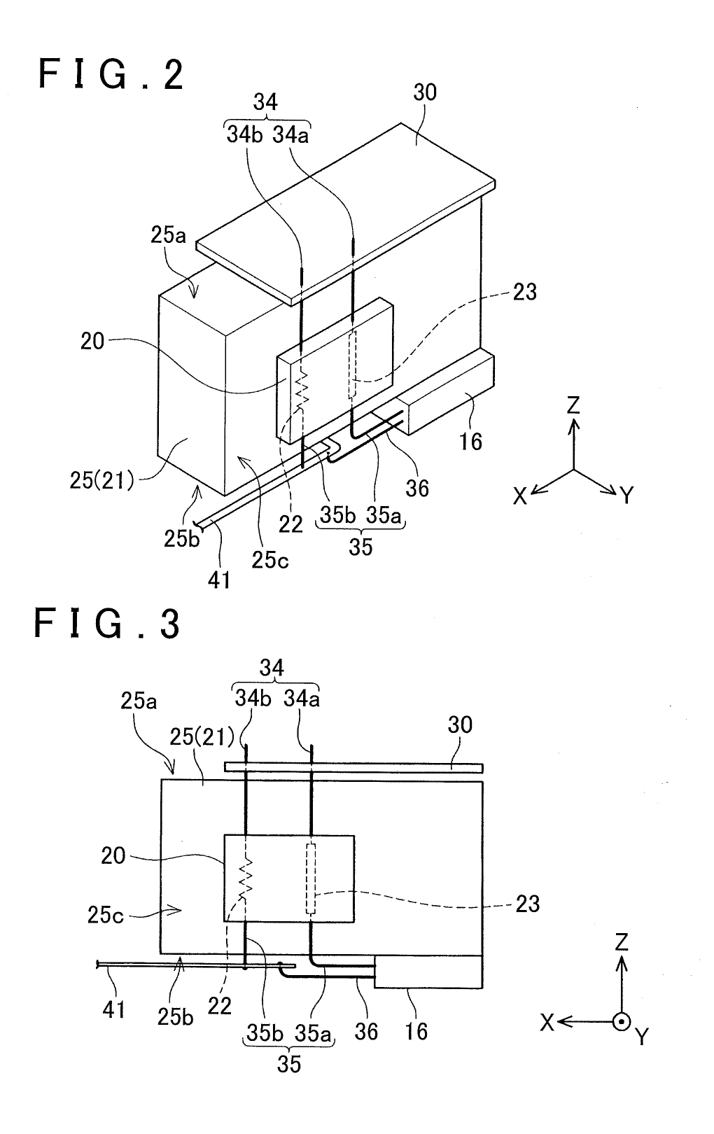

FIG. 2 is a perspective view showing the layout of the capacitor 21, discharge resistors, and so forth, and FIG. 3 is a side view thereof. In FIG. 2 and FIG. 3, the first discharge resistor 22 and the conducting path 23, which are depicted with broken lines, are mounted in a rectangular parallelepiped that represents the first substrate 20. The devices shown in FIG. 2 and FIG. 3 are housed in a case of the electric power conversion system 5. Components that constitute the voltage converter circuit 4, components that constitute the inverter circuit 6, circuit that constitutes the controller 8, etc. are also housed in the case of the power conversion system 5, but not illustrated in these figures. The case of the electric power conversion system 5 itself is not illustrated, either.

The capacitor 21 is housed in a case 25 in the form of a generally rectangular parallelepiped. The second substrate 30 is located so as to be opposed to an upper face 25a of the case 25, and the second discharge resistor 16 is located so as to be opposed to a lower face 25b of the case 25. In other words, the second substrate 30 and the second discharge resistor 16 are located so as to be respectively opposed to two parallel faces of the case 25 of the capacitor 21.

The first substrate 20 is attached to a side face 25c of the case 25. Namely, the first substrate 20 is attached to a face (the side face 25c) perpendicular to the two faces (the upper face 25a and lower face 25b) to which the second substrate 30 and the second discharge resistor 16 are opposed, respectively.

Two connecting pins 34 extend upward from the first substrate 20, and are connected to the second substrate 30. Also, two electric cables 35 extend downward from the first substrate 20. One of the electric cables 35a is connected to the second discharge resistor 16. One of the connecting pins 34a and the above-indicated one electric cable 35a are electrically connected by the conducting path 23, within the first substrate 20. Namely, the conducting path 23 that electrically connects the second substrate 30 with the second discharge resistor 16 is routed through the first substrate 20. In other words, in the layout as described above, the substrate (the first substrate 23) in which the first discharge resistor 22 is mounted is utilized as a relay of cables for electrically connecting the second discharge resistor 16 with the second substrate 30.

The other connecting pin 34b is connected to one end of the first discharge resistor 22 within the first substrate 20. The other electric cable 35b connects the other end of the first discharge resistor 22 with a positive bus bar 41. The positive bus bar 41 provides a part of the high-potential-side electric power line P as shown in FIG. 1. An electric cable 36 that extends from the second discharge resistor 16 is also connected to the positive bus bar 41.

Advantages of the above-described layout will be described. The second discharge resistor 16 releases a large amount of heat when it rapidly discharges the capacitor 21. Namely, the amount of heat generated by the second discharge resistor 16 is large. On the other hand, a large number of electronic components are mounted in the second substrate 30 in which the control circuit for the second discharge resistor 16 is mounted, and the second substrate 30 may be affected by the heat generated by the second discharge resistor 16 if it is located close to the second discharge resistor 16. In the layout as described above, the capacitor 21 is interposed between the second discharge resistor 16 and the second substrate 30; therefore, the influence of the heat of the second discharge resistor 16 on the second substrate 30 can be reduced. Also, the second discharge resistor 16 and the second substrate 30 are electrically connected to each other via the first substrate 20, which leads to space-saving, i.e., reduction of space required for wiring.

The first substrate 20, second substrate 30, and the second discharge resistor 16 are located so as to be opposed to three faces of the capacitor 21 (the capacitor case 25). This layout improves the space efficiency of the first substrate 20, second substrate 30, second discharge resistor 16, and the capacitor 21.

While one embodiment of the invention has been described in detail, this embodiment is merely exemplary, and is not supposed to limit the scope of the invention.

The scope of the invention as defined by the appended claims includes those obtained by making various modifications or changes to the illustrated embodiment. Technical elements described in this specification or drawings show technical utility when taken alone or in various combinations, and are not limited to combinations as described in the claims at the time of filing of this application.

What is claimed is:

1. An electric power conversion system for an electric vehicle, which is operable to convert DC power of a battery into AC power, and supply the AC power to a motor, comprising:
a capacitor operable to smooth an electric current of the battery;
a first discharge resistor operable to discharge the capacitor;
a first substrate attached to a case of the capacitor;
a second discharge resistor operable to discharge the capacitor, an amount of heat per unit time per unit current generated by the second discharge resistor is larger than an amount of heat per unit time per unit current generated by the first discharge resistor; and
a second substrate in which a circuit that controls the second discharge resistor is mounted, wherein
the case of the capacitor is located between the second discharge resistor and the second substrate, and an electrically conducting path that electrically connects the second substrate with the second discharge resistor is routed through the first substrate.

2. The electric power conversion system according to claim 1, wherein the first discharge resistor is mounted in the first substrate.

3. The electric power conversion system according to claim 3, wherein the case of the capacitor is a generally rectangular parallelepiped including a first face, a second face parallel to the first face, and a third face that intersects with the first face and the second face, and the second discharge resistor and the second substrate are located so as to be respectively opposed to the first and second faces of the case of the capacitor, the first substrate is attached to the third face of the case of the capacitor.

4. The electric power conversion system according to claim 1, wherein the case of the capacitor is a generally rectangular parallelepiped including a first face, a second face parallel to the first face, and a third face that intersects with the first face and the second face, the second substrate disposed so as to oppose one of the first face or second face, and the second discharge resistor disposed so as to oppose the other of the first face or second face.

5. The electric power conversion system according to claim 1, wherein the first discharge resistor and the second discharge resistor are connected in parallel with the capacitor, and the control circuit mounted in the second substrate is operable to connect the second discharge resistor with the capacitor or disconnect the second discharge resistor from the capacitor.
